(19) United States
(12) Patent Application Publication
(10) Pub. No.: US 2005/0161944 A1
(43) Pub. Date: Jul. 28, 2005

(54) Flange mounting device for connecting marine exhaust conduit to engine turbocharger

(76) Inventor: Woodrow E. Woods, Riviera Beach, FL (US)

Correspondence Address: MARK D. BOWEN, ESQ.;STEARNS, WEAVER, MILLER, WEISSLER, ALHADEFF & SITTERSON PA., 200 EAST BROWARD BLVD., SUITE 1900, FT. LAUDERDALE, FL, 33301, US

(21) Appl. No.: 11/043,201

(22) Filed: Jan. 26, 2005

Related U.S. Application Data
(60) Provisional application No. 60/539,142, filed on Jan. 26, 2004.

(51) Int. Cl. F16L 39/00

(52) U.S. Cl. 285/133.11; 285/405

(57) ABSTRACT

An improved flange particularly adapted for use in mounting marine exhaust conduit to the turbocharger of a marine engine. The flange includes a rigid mounting ring having a plurality of radially projecting stop blocks circumferentially positioned at approximately 0, 90, 180, and 270 degrees. The radially projecting blocks function to limit rotation of the flange within 60 degrees of travel. Turbocharger mounting brackets engage the flange between circumferentially adjacent radially projecting blocks thereby preventing rotation of the exhaust conduit/flange assembly to positions wherein cooling water would tend to flow into the turbocharger/engine.

### CROSS-REFERENCE TO RELATED APPLICATIONS

This application claims the benefit of U.S. Provisional Patent Application Ser. No. 60/539142, filed Jan. 26, 2004.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates generally to exhaust systems for internal combustion engines, and, more particularly, to a flange for connecting an exhaust conduit to a marine engine wherein the exhaust conduit is prevented from being positioned in certain improper configurations.

2. Description of Related Art

Marine vessels are typically configured with a propulsion system having an internal combustion engine mounted internally within the vessel hull. Exhaust generated by the engine is commonly routed through exhaust conduit to the stern or rear of the vessel via one or more exhaust ducts and is discharged through one or more exhaust ports formed in the transom. In a large number of applications the exhaust is routed through a turbo charger that has an outlet in communication with an exhaust conduit. Water is often injected into the exhaust stream to cool the exhaust gas flowing through the exhaust system, and one or more silencers may be installed within the exhaust conduit to silence noise associated with the engine and exhaust gases.

A variety of structures are known in the background art for use in silencing marine exhaust noise. The present inventor has invented a number of novel marine exhaust components that have greatly improved the silencing and efficiency of marine exhaust systems. Among those inventions developed by the present inventor are: U.S. Pat. No. 4,918,917 for a Liquid Cooled Exhaust Flange; U.S. Pat. No. 5,196,655, for a Muffler for Marine Engines; U.S. Pat. No. 5,228,876, for a Marine Exhaust System Component comprising a heat resistant conduit; U.S. Pat. No. 5,262,600 for an In-line Insertion Muffler for Marine Engines; U.S. Pat. No. 5,444,196 for an improved In-line Insertion Muffler for Marine Engines; U.S. Pat. No. 5,504,280, for a Muffler for Marine Engines; U.S. Pat. No. 5,616,893, for a Reverse Entry Muffler With Surge Suppression Feature; U.S. Pat. No. 5,625,173, for a Single Baffle Linear Muffler for Marine Engines; U.S. Pat. No. 5,718,462 for Muffler Tube Coupling With Reinforcing Inserts; and U.S. Pat. No. 5,740,670, for a Water Jacketed Exhaust Pipe for Marine Exhaust Systems.

Problems have been experienced, however, when the exhaust conduit is installed or otherwise positioned in a manner that allows for water to flow back to the turbocharger outlet and/or engine exhaust manifold. More particularly, since water is injected into the exhaust conduit for cooling purposes, it is important that the exhaust conduit be angled downward away from the engine and turbo charger to prevent cooling water in the conduit from flowing back toward the turbocharger when the engine in shut down. Due to space limitations invariably found in marine engine rooms, most exhaust conduits are connected to the turbo charger by an elbow section so as to route the conduit close to the engine. As a result, mechanics and/or installers have been known to install or move the elbow/conduit in rotated configurations wherein the conduit follows and ascending path from the turbo charger rather than a descending path. When the exhaust conduit is installed in the ascending configuration cooling water in the conduit will flow back toward the engine turbocharger when the engine is shut down. As should be apparent, exposing the engine and/or turbocharger to the corrosive effects of saltwater leads to rapid failure.

Accordingly, there exists a need for an improved flange for use in mounting an exhaust elbow conduit to a marine engine and/or turbocharger so as to prevent rotational positioning of the elbow/conduit in an ascending configuration.

### BRIEF SUMMARY OF THE INVENTION

The present invention provides an improved flange particularly adapted for use in mounting marine exhaust conduit to the turbocharger of a marine engine. The flange comprises a rigid mounting ring having a plurality of radially projecting stop blocks circumferentially positioned at approximately 0, 90, 180, and 270 degrees. The radially projecting blocks function to limit rotation of the flange within 60 degrees of travel. The flange is connected to an exhaust conduit, typically an elbow and mounted directly to the outlet of the engine turbocharger using suitable fasteners and brackets. The turbocharger mounting brackets engage the flange between circumferentially adjacent radially projecting blocks thereby preventing rotation of the exhaust conduit/flange assembly to positions wherein cooling water would tend to flow into the turbocharger/engine.

Accordingly, it is an object of the present invention to provide an improved flange for use in connecting a marine exhaust conduit to a turbo charger.

Another object of the present invention is to provide an improved marine exhaust conduit mounting flange that limits positioning of the exhaust conduit so as to prevent cooling water from migrating into the turbo charger and/or engine.

In accordance with these and other objects that will become apparent hereinafter, the instant invention will now be described with particular reference to the accompanying drawings.

### BRIEF DESCRIPTION OF THE SEVERAL VIEWS OF THE DRAWINGS

FIG. 1 is a schematic representation of a flange adapted with radially projecting stop blocks according to the present invention;

FIG. 2 is a side view of a flange according to a preferred embodiment of the the present invention;

FIG. 3 is a front view thereof;

FIGS. 4 and 5 depict a flange according to the present invention with an exhaust conduit mounted thereto; and

FIGS. 6 and 7 are corresponding top views thereof.

### DETAILED DESCRIPTION OF THE INVENTION

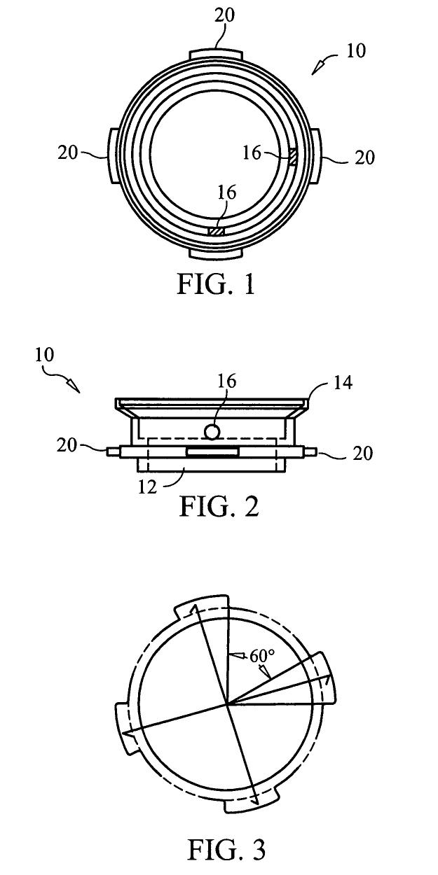

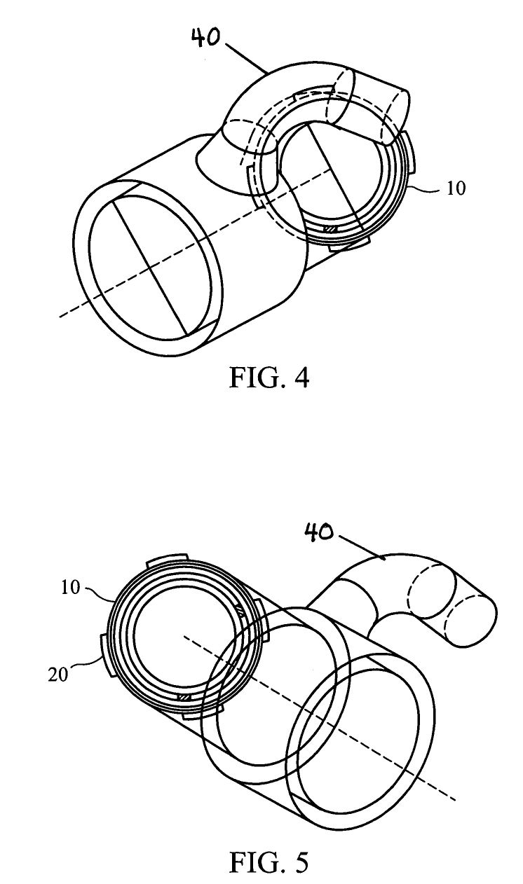

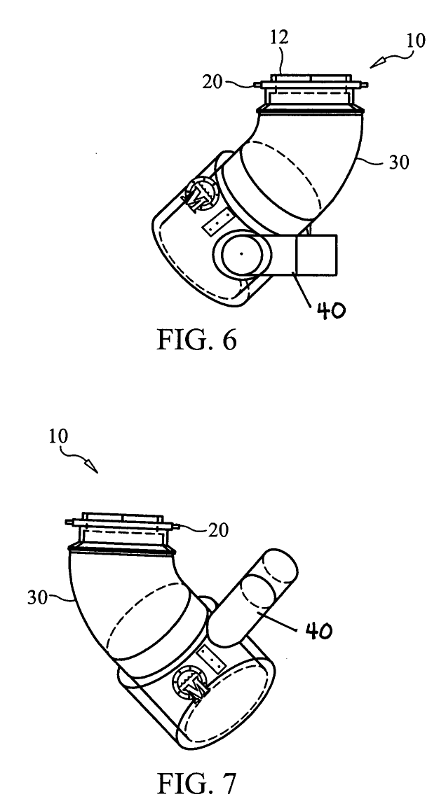

With reference now to the drawings FIGS. 1-7 depict a flange for use in mounting an exhaust conduit to a marine engine according to the present invention. As best depicted in FIGS. 1-3, a preferred embodiment of the present invention comprises an annular rigid flange 10 particularly adapted for use in mounting marine exhaust conduit to the turbocharger of a marine engine. Flange 10 is preferably fabricated from corrosion resistant steel, such as galvanized and/or stainless steel, however, any suitable metallic or non-metallic material is considered within the scope of the invention. Flange 10 comprises a rigid mounting ring having a first or inlet side including a projecting cylindrical wall 12 sized for mating engagement with the outlet of a turbocharger on a marine engine. Flange 10 also includes a second or outlet side having a projecting cylindrical wall structure 14 adapted to receive a tubular exhaust conduit connected thereto. Flange 10, and particularly cylindrical wall structure 14, defines at least one, and preferably two, female threaded through bores referenced as 16 which are normally plugged with a suitable male threaded plug. Through bores 16 function to provide testing and sensing ports such that a technician may measure the temperature and/or pressure of the exhaust.

A significant aspect of the present invention involves adapting the above-referenced structure with radially projecting stop blocks, referenced as 20. In a preferred embodiment four (4) stop blocks 20 are circumferentially positioned at approximately at circumferentially spaced locations, preferably 0, 90, 180, and 270 degrees respectively. Each stop bock 20 preferably has opposing sides spaced in correspondence with a 30 degree angular segment projected onto the outer circumference of flange 10. Accordingly, there exists 60 degrees of circumference between circumferentially adjacent stop block sides. Radially projecting stop blocks 20 function to limit rotation of the flange within 60 degrees of travel.

As best depicted in FIGS. 4-7, cylindrical wall structure 14 of flange 10 is connected to an exhaust conduit 30, typically an elbow section of conduit, in fluid communication with a downstream muffler and/or silencing element. In addition, flange 10, and particularly projecting cylindrical wall 12 on the first side thereof is further mounted directly to the outlet of the engine turbocharger using suitable fasteners and brackets (not shown). The turbocharger mounting brackets, typically L-shaped or angle brackets, engage the flange between circumferentially adjacent radially projecting blocks thereby preventing rotation of the exhaust conduit/flange assembly to positions wherein cooling water would tend to flow into the turbocharger/engine. More particularly, flange 10 is mounted to the engine turbocharger by L-shaped brackets that engage the flange between each of the circumferentially spaced stop blocks. Cooling water is introduced into the exhaust conduit downstream of flange 10 by a cooling water pipe, referenced as 40. Accordingly, should a mechanic attempt to rotate the exhaust elbow, one or more of the brackets will come into contact with one or more of the stop blocks thereby preventing further rotation of the flange. By restricting rotation of flange 10 and the exhaust conduit elbow connected thereto, the flange of the present invention prevents positioning of the exhaust conduit in configurations wherein the exhaust conduit would be angled upward relative to the turbocharger such that cooling water contained therein would tend to flow downward toward and/or into the turbo charger and/or engine when the engine shuts down thereby stopping the flow of exhaust gas.

The instant invention has been shown and described herein in what is considered to be the most practical and preferred embodiment. It is recognized, however, that departures may be made therefrom within the scope of the invention and that obvious modifications will occur to a person skilled in the art.

1. A mounting flange for use in connecting engine exhaust conduit to a marine engine, said mounting flange comprising:
an annular rigid body having an inlet side and an outlet side;
said inlet side including an axially projecting cylindrical wall;
said outlet side adapted for connection to engine exhaust conduit; and
at least one stop block radially projecting from said body.

2. A mounting flange according to claim 1, wherein said body further defines at least one internally threaded radial through bore test port and an externally threaded plug in removable threaded engagement with said test port.

3. A mounting flange for use in connecting engine exhaust conduit to a marine engine, said mounting flange comprising:
an annular rigid body having an inlet side and an outlet side;
said inlet side including an axially projecting cylindrical wall;
said outlet side adapted for connection to engine exhaust conduit;
a plurality of circumferentially spaced stop blocks radially projecting from said body for limiting rotational adjustment of said mounting flange.

4. A mounting flange according to claim 3, wherein said body further defines at least one internally threaded radial through bore test port and an externally threaded plug in removable threaded engagement with said test port.

5. A mounting flange according to claim 3, wherein said body defines four radially projecting stop blocks in circumferentially spaced relation.

6. A mounting flange according to claim 5, wherein each stop block has opposing sides spaced in correspondence with a 30 degree angular segment projected to the outer circumference of said body.

7. A mounting flange according to claim 6, wherein said stop blocks are spaced 60 degrees from one another.
